(19) United States
(12) Patent Application Publication
(10) Pub. No.: US 2001/0048706 A1
(43) Pub. Date: Dec. 6, 2001

(54) Saturable reflector and saturable absorber

(76) Inventors: Eckard Deichsel, Heidenhain (DE); Roland Jager, Ulm (DE); Peter Unger, Ulm (DE)

Correspondence Address: EUGENE E. RENZ, JR., P.C., P.O. Box 2056, 205 North Monroe Street, Media, PA, 19063-9056, US

(21) Appl. No.: 09/877,923

(22) Filed: Jun. 8, 2001

(30) Foreign Application Priority Data
Jun. 23, 1999 (DE) 10030672.1

(51) Int. Cl. H01S 3/08

(52) U.S. Cl. 372/107

(57) ABSTRACT

The invention relates to a saturable reflector and a saturable absorber which are each arranged as a layer sequence (3) on a substrate (1) and is characterized in that the layer sequence (3) contains a strained-layer single quantum well (6) and a cap layer (7), whereby the material composition of the single quantum well (6), its layer thickness and its strain in the layer structure within a wavelength range all serve to define an absorbing effect, moreover, a saturable effect is defined by the selection of the position within the standing wave of a laser resonant cavity.

### FIELD OF THE INVENTION

The invention relates to a saturable reflector and to a saturable absorber, each consisting of several layers structured on a substrate, especially for use in a solid-state laser resonant cavity.

### BACKGROUND OF THE INVENTION

In U.S. Pat. No. 4,860,296, Chemla describes a resonant cavity mirror for a laser cavity in which a layer structure having a saturable absorbing effect and finally an anti-reflective coating are applied onto a reflector mirror. The layer thicknesses within the layer structure are selected in such a way that the layers with the actually saturable absorbing effect lie in the appertaining standing wave maximum and thus a solid phase matching with a

$$\frac{λ}{2}$$

condition is fulfilled.

In U.S. Pat. No. 5,701,327 (CUNNINGHAM), a saturable Bragg reflector is described that consists of the layers consecutively arranged on each other and listed below: a substrate made of gallium arsenide (GaAs), a Bragg reflector consisting of alternating layers made of aluminum arsenide (AlAs) and gallium arsenide (GaAs), and a strain relief layer made of indium phosphide (InP) applied onto the Bragg reflector and having a layer thickness of

$$\frac{λ}{2} .$$

One or more quantum wells made of indium-gallium arsenide/indium phosphide (InGaAs/InP) are embedded within this strain relief layer. This solution utilizes the strain within a

$$\frac{λ}{2}$$

layer in which at least one quantum well is incorporated. The

$$\frac{λ}{2}$$

thick strain relief layer is the layer of the saturable Bragg reflector that is adjacent to the surrounding medium. A relatively complex process control is supposed to achieve that the quantum wells are arranged in a predetermined area of the strain reduction within the strain relief layer in order to obtain an additional recombination source for charge carriers.

The objective being pursued is to create ultrashort optical pulses (110 fs) with a relatively large bandwidth (26 nm) for communication applications (laser wavelength of 1541 nm). Here, a phase relation of the position of the quantum wells to the standing wave is created that lies outside of the standing wave maximum.

Robert M. Kolbas et al., in “Strained-Layer InGaAs-GaAs-AlGaAs Photopumped and Current Injection Lasers”, IEEE Journal of Quantum Electronics, Vol. 24, No. 8, 1988, cite the layer system GaAs-InGaAs-GaAs as an example of a quantum well hetero-structure. The indium-gallium arsenide layer can be made with a varying indium mole fraction. This layer system is characterized by the fact that, with a selection of the indium content and of a layer thickness for the single quantum well, a working wavelength can be specified within a broad wavelength range (see FIG. 6 there).

J. -Y. Marzin, M. N. Charasse and B. Sermage in “Optical investigation of a new type of valence-band configuration in InₓGa₁₋ₓAs-GaAs strained superlattices”, Phys. Rev., Vol. B31, pp. 8298-8301, 1985, describe a split of the valence band of an InGaAs layer into a “heavy-hole (HH) band” and a “light-hole (LH) band” as a result of mechanical stress that arises from the lattice mismatch between InGaAs and GaAs (see FIG. 1 there). FIG. 2 illustrates how the absorption behavior changes as a function of the energy band gap or as a function of the wavelength of a laser radiation in relation to the layer thickness and thus to the magnitude of the strain of the InGaAs layer within the GaAs layers. Until now, such layer systems have only been used for semiconductor lasers.

Keller, U. et al., on page 443, FIG. 10, in “Semiconductor Saturable Absorber Mirrors (SESAM's) for Femtosecond to Nanosecond Pulse Generation in Solid-State Lasers”, IEEE Journal of Selected Topics in Quantum Electronics, Vol. 2, No. 3, September 1996, show a layer structure that is a saturable reflector. A first layer sequence (Si substrate, epoxy and Ag) forms a reflector. Another layer sequence uses semiconductor layers to form the saturable absorber that contains two 10 nm-thick absorber layers made of GaAs.

### SUMMARY OF THE INVENTION

The objective of the present invention is to create a relatively simply structured saturable reflector or a saturable absorber with a quantum well heterostructure, especially for use in a solid-state laser resonant cavity. They should be highly rated in terms of power and especially suited for laser output powers of more than 5 watts. Moreover, the saturable reflector or the saturable absorber should be used in a laser resonant cavity that generates laser pulses at a width ranging from 0.1 ps to 100 ps.

The invention relates to a saturable reflector for a laser wavelength λ_{L} with which a reflector is applied onto a surface of a substrate, and a layer sequence consisting of several semiconductor layers with a saturable absorbing effect is applied onto the reflector. The invention also relates to a saturable absorber for a laser wavelength λ_{L} that consists of the layer sequence of several semiconductor layers with a saturable absorbing effect on a substrate that is transparent for the laser wavelength.

The invention for the saturable reflector is characterized in that the layer sequence contains a strained-layer single quantum well and a cap layer, whereby the material composition of the single quantum well, its layer thickness and its strain in the layer structure within a wavelength range define an absorbing effect, and moreover, the degree of the saturable effect is defined by the selection of the distance between the strained single quantum well and the boundary surface of the cap layer adjacent to a surrounding gaseous medium. It is important for this wavelength range to include the laser wavelength λ_{L} at which the saturable reflector is to be operated.

The invention for the saturable absorber is characterized in that the layer sequence contains a strained-layer single quantum well and a cap layer, whereby the material composition of the single quantum well (6), its layer thickness and its strain in the layer structure within a wavelength range define an absorbing effect, and moreover, a saturable effect is defined by the selection of the position of the absorber within the standing waves of a laser resonant cavity.

It is important for this wavelength range to contain the laser wavelength λ_{L} at which the saturable absorber is to be operated. For the saturable function of the saturable reflector or of the saturable absorber, it is very useful for a pronounced absorption maximum of the absorption course of the strained-layer single quantum well to lie at the laser wavelength λ_{L}. A lattice strain that is favorable for the function desired here lies in a range that is defined by the lattice mismatch between the single quantum well and the surrounding material in the order of magnitude between 0.005 and 0.02 nm. If the mismatch is less, the strain disappears whereas if the mismatch is greater, problems arise in terms of the adherence of the layers.

Here, the position of the strained-layer single quantum well, relative to the standing waves that are forming in a laser resonant cavity, must not lie within an intensity mini-mum of the incident and/or reflected radiation having the laser wavelength λ_{L}. The new insight is that the targeted lattice strain of the single quantum well leads to systematically achievable and high-quality components having the saturable absorbing effect needed for a high-performance laser. By selecting the layer thickness of the single quantum well and its material composition, a desired absorption behavior in a layer sequence can be systematically achieved. The surrounding gaseous medium is advantageously air or a dried gas, for example, nitrogen. Surprisingly, the use of a saturable reflector or absorber according to the invention in a laser resonant cavity exhibits excellent properties. For example, the sufficiently short laser pulses in the picosecond range needed for image projection by means of laser radiation are generated at an appropriate power resistance that corresponds to a continuous wave (cw) output power of 40 watts. Its properties are not very temperature-dependent. Cooling is only necessary in order to dissipate the resultant wasted heat. The output power, the pulse spacing and the pulse duration are virtually constant over the course of time of one day.

Surprisingly, it was also found that the absorption behavior resulting from the lattice strain of the single quantum well can be set with at least one of the surrounding layers as a function of the wavelength in such a way that a pronounced absorption maximum occurs at the intended laser wavelength λ_{L}.

The strained-layer single quantum well is not subject to any Fabry-Perot resonance condition here. However, for reasons of its application and thus inevitably, it lies within the standing waves that are forming in a laser resonant cavity. Its function is comparable to that of a dye absorber in a dye laser or Nd:YAG laser. Practically, the reflector is dimensioned in such a way that a predefined, high reflectivity is achieved for the laser wavelength λ_{L} with the smallest possible number of individual layers. A reflectivity of 98% is generally sufficient for laser operations in the saturated state. Thus, for example, only about 30 individual layers are needed for a Bragg reflector. This relatively low number of individual layers translates into correspondingly less manufacturing work. Far fewer layers are needed for a metal mirror.

It is more important, however, that the relatively small number of individual layers of the components according to the invention in connection with an appropriate management and process control of the coating procedure will lead to a very homogeneous layer structure perpendicular to the beam direction of the laser-internal radiation. This, in turn, makes it possible to use a relatively low focussing of the laser-internal radiation on the saturable reflector or the saturable absorber. The spot diameter on each component here can be more than 200 μm and can be expanded to about 5 mm, whereby a neat, constant mode synchronization of the laser takes place. This relatively large spot diameter considerably reduces the power density within the saturable absorbing layer and its immediate vicinity. A typical value is less than 100 kW/cm² down to about 2 kW/cm², relative to the continuous wave (cw) operation of the laser. In actual practice, however, the work is performed as close as possible to the load limit of the saturable reflector or of the saturable absorber in order to achieve a maximum laser output power over a predefined lifetime of the source of laser radiation. The relatively large spot on the saturable reflector or on the saturable absorber in the laser resonant cavity allows a relatively low power density at a high output power of the laser, which can lie in the range above 40 watts.

The lattice strain of the single quantum well in the saturable reflector occurs with the last layer of a reflector adjacent to its one side and/or with the cap layer adjacent to its other side and, correspondingly in the case of a saturable absorber, with the cap layer and/or with the substrate.

The above-mentioned layers, together with the single quantum layer, form a hetero-structure, that is to say, a so-called quantum well is formed. The invention allows a simple calculation or dimensioning of a saturable reflector or absorber with the strained-layer single quantum well heterostructure, since the function of the individual components—namely, the reflector and/or the strained-layer single quantum well heterostructure—is the basis of such calculations. Through the meticulous dimensioning of the lattice strain of the single quantum well and its layer thickness, a simple new possibility exists to systematically influence the absorption properties of the single quantum well over a broad range and to coordinate them precisely with the laser wavelength of the solid-state laser. Selectable parameters for dimensioning one of the components according to the invention for a laser wavelength are the material selection for the heterostructure and the thickness of the single quantum well.

Moreover, the saturable-absorbing properties are defined by the distances between the position of the single quantum well and the reflector on the one hand, and the boundary surface of the cap layer adjacent to the surrounding medium on the other hand, or, in the case of a saturable absorber, its position in the laser resonant cavity. The absorption behavior and the position of the strained single quantum well within the layer sequence essentially determine the pulse duration of a mode-synchronized laser in which one of the components is used. The position of the strained-layer single quantum well within the layer sequence dimensioned for the laser wavelength is defined on the basis of the criterion of the desired or required laser resistance of the resonant cavity mirror or of the saturable absorber and the pulse repetition frequency. However, this is only optimal in conjunction with the concrete dimensioning of the laser resonant cavity, i.e. of the desired output power and of the beam cross section. It is important for the position of the strained single quantum well to lie so far away from a standing wave minimum of the laser radiation in the laser resonant cavity that the desired saturable absorbing effect that generates the short laser pulses in the picosecond range is maintained. Therefore, the strained single quantum well is preferably located outside of an intensity maximum of the laser radiation. Practically speaking, the invention utilizes a position of the single quantum well within the layer sequence that lies between a standing wave maximum and a standing wave minimum of the laser radiation.

It requires the least amount of work to strain the single quantum well with the last layer (of the layer situated furthest towards the outside) of the reflector. However, this entails restrictions in terms of material selection and processing technology, if a desired intensity of the standing wave in the saturable absorbing layer is to be reproducibly set, since this can then only be additionally set via the material and the thickness of the cap layer. Since this cap layer has to have primarily passivating and perhaps also anti-reflective properties, the selection of suitable materials is very limited.

In another embodiment of the saturable reflector, it is advantageously provided with an intermediate layer that is situated on the last layer of the reflector or, in the case of the saturable absorber, the intermediate layer is applied onto the substrate. Therefore, the layer sequence contains the intermediate layer that is adjacent to the reflector or to the substrate. The intermediate layer should be strain-free with respect to the last layer of the reflector or with respect to the substrate. Especially with a Bragg reflector, it is an important prerequisite that the layers be strain-free for stable functioning. On the inter-mediate layer, the single quantum well is applied so as to be strained. The cap layer is then applied onto the strained-layer single quantum well. The strained-layer single quanturn well, with the intermediate layer and the cap layer, forms a heterostructure. With the selection of the thicknesses of the intermediate layer and of the cap layer, the saturable absorbing effect of the saturable reflector or of the saturable absorber can be achieved highly reproducibly so that its use in a laser resonant cavity supplies the desired short mode-synchronized laser pulses.

Another advantageous embodiment of the saturable reflector or of the saturable absorber consists in that the strained-layer single quantum well is embedded in the material of the intermediate layer, whereby the strained-layer single quantum well, together with the parts of the intermediate layer, forms a heterostructure. Here, it has been found that the degree of lattice strain of the single quantum well can be achieved reproducibly and the properties of the strained-layer single quantum well are not influenced by other material properties of the cap layer.

Through the selection of the same or different layer thicknesses of the parts of the layers, an additional possibility is obtained for setting the position of the strained-layer single quantum well relative to the standing wave curve being formed inside the laser resonant cavity and thus its switching effect and power resistance. These measures are also accordingly provided in the case of the saturable absorber according to the invention and lead to the corresponding effects. The saturable effect of such components is generally defined by a selection of the position within the standing waves of a laser resonant cavity.

An especially advantageous layer structure is achieved if, in the reflector or in the substrate, i.e. within the layer sequence of the reflector and towards the substrate, and within each the intermediate layer that has grown thereon, little or no lattice strain occurs in comparison to the strain of the single quantum well. This means that the lattice mismatches of the materials of the reflector and/or of the substrate and of the material of the intermediate layer are smaller than 0.005 nm, especially smaller than 0.001 nm. In order to fulfill this requirement and in order to minimize the amount of work involved in manufacturing the saturable reflector or saturable absorber, it is especially advantageous if one of the substances used to make the reflector or the substrate is also one of the substances used to make the intermediate layer.

The reflector is structured for many laser applications, especially as a Bragg reflector for a predefined reflectivity (number of layer sequences). The saturable reflector consists of the Bragg reflector, which consists of a first material with a refractive index n_{H} and of a second material with the lower refractive indices n_{L}, and furthermore, the intermediate layer and/or the cap layer are made of one of these materials.

However, the reflector can also be a highly reflecting metal mirror onto which the layer sequence with the saturable absorbing layer is applied. In this case, the smallest number of layers can be used.

An advantageous embodiment of a saturable reflector is one in which the substrate consists of gallium arsenide (GaAs) and the reflector is a Bragg reflector that consists of individual layers, each of which has a thickness that is

$$\frac{{λ}_{L}}{4 * {n}_{GaAs}}$$

for the first material with the refractive index n_{H} with undoped gallium arsenide (GaAs) and that is

$$\frac{{λ}_{L}}{4 * {n}_{AlAs}}$$

for the second material with the lower refractive indices n_{L} with undoped aluminum arsenide (AlAs), the intermediate layer is made of gallium arsenide (GaAs) on which or within which the single quantum well made of indium-gallium arsenide (InₓGa₁₋ₓAs) is strained, whereby the indium mole fraction (x) and the gallium mole fraction (1−x) in the indium-gallium arsenide compound and its layer thickness define the absorbing effect as a function within a wavelength range, this wavelength range comprises the laser wavelength λ_{L}, at which a maximum of the absorption curve lies at this laser wavelength. The saturation effect of the saturable Bragg reflector inside a laser resonant cavity is defined by the position of the strained single quantum well with respect to the boundary of the reflector. The Bragg reflector consists of 15 to 50 individual layers, which form mirror pairs. The number of mirror pairs determines its reflectivity (see Orazio Svelto: “Principles of Lasers”, fourth edition, Plenum Press, 1998). For example, a reflectivity of the resonant cavity mirror of 98.77% is achieved with 28 mirror pairs. For reasons of practicality, it is always desirable to work with as few layers as possible.

The properties of the material system consisting of gallium arsenide/aluminum arsenide have been sufficiently studied, so that these materials can be grown by epitaxy on the substrate made of gallium arsenide relatively easily and they yield the requisite homogeneity of the layer thicknesses and of the layer structure.

The dimensioning of a strained-layer single quantum well made of indium-gallium arsenide (In₁₋ₓGaₓAs) in gallium arsenide (GaAs) takes place in several steps. First of all, the absorption curve of the strained single quantum well has to be ascertained as a function of the wavelength and depending on its layer thickness, as this can partially be derived from the literature; see J. -Y. Marzin, M. N. Charasse and B. Sermage: “Optical investigation of a new valence-band configuration in InₓGa₁₋ₓAs-GaAs strained superlattices”, Phys. Rev. Vol. B31, pp. 8298-8301, 1985; there especially FIG. 2.

For the desired wavelength of the laser light, many value pairs can be selected for a layer thickness and a material composition with which the strained single quantum well displays an absorption maximum.

Now, by applying the diagram published in R. M Kolbas, N. G. Anderson, W. D. Laidig, Yongkun Sin, Y. C. Lo, K. Y. Hsien, Y. L. Yang: “Strained-Layer InGaAs-GaAs-AlGaAs Photopumped and Current Injection Lasers”, IEEE Journal of Quantum Electronics, Vol. 24, No. 8, 1988 (FIG. 6 there), a selection of one of the ascertained value pairs is made for the intended wavelength of the laser.

Strained-layer single quantum wells have been used so far in the production of semi-conductor lasers. Surprisingly, however, it has been found that the fundamental approach of layer dimensioning and layer formation can be transferred to the production of a saturable Bragg reflector. Here, the dimensioning of the indium mole fraction x and of the layer thickness, and thus of a desired absorption behavior, takes place in such a way that a pronounced maximum of the absorption curve lies within a wavelength range at the laser wavelength of a solid-state laser resonant cavity.

For a laser wavelength of 1064 nm, the indium mole fraction is 33% at a thickness of the single quantum well of about 7 nm, as can be seen in FIG. 2 in R. M. Kolbas, N. G. Anderson, W. D. Laidig, Yongkun Sin, Y. C. Lo, K. Y. Hsien, Y. L. Yang: “Strained-Layer InGaAs-GaAs-AlGaAs Photopumped and Current Injection Lasers”, IEEE Journal of Quantum Electronics, Vol. 24, No. 8, 1988, when the energy band gap E [in eV] is converted into the wavelength according to the formula

$$λ = \frac{h * c}{E} ,$$

here the laser wavelength λ_{L}. The saturation behavior and thus the switching behavior generated in a laser resonant cavity and thus the pulse duration can be set especially well and reproducibly through the selection of the position of the strained indium-gallium arsenide layer within the intermediate layer. The pulse duration and the absorption behavior, in turn, determine the power resistance of the saturable reflector in a laser resonant cavity.

Consequently, the gallium arsenide layers of the intermediate layer always serve for straining in the case of the relatively thin single quantum well made of indium-gallium arsenide and simultaneously serve as a protective layer vis-a-vis the surrounding media.

In a special case, the strained indium-gallium arsenide layer is embedded within two optically approximately λ_{L}/4-thick gallium arsenide layers. Then the indium-gallium arsenide layer, in connection with the Bragg reflector, is in the standing wave maximum within a laser resonant cavity. This has the drawback of a maximum energy density at this place. However, this drawback is eliminated in that the diameter of the bundle of rays striking the resonant cavity mirror is selected so as to be relatively quite large; instead of the usual 10 μm-spot diameter, a spot diameter of more than 200 μm can be selected. However, this is only possible with a highly homogeneous layer structure, something that is facilitated by the relatively quite simple layer structure and the relatively small number of individual layers.

The indium-gallium arsenide layer is a low-temperature layer. The growth temperature should be below 500° C. [932° F.] in order to reduce the lifetime of the charge carrier and to generate sufficiently short laser pulses. However, a low-temperature layer ensures that the saturable absorber, even with the optimization of the layer structure in terms of its power resistance, supplies adequately short laser pulses that are advantageous for many technical applications in the range from 1 to 10 picoseconds. Technical applications are, for example, material processing or image projection by means of laser light. Advantageously, as generally described above, an anti-reflective coating is applied as a cap layer onto the outer gallium arsenide layer, facing away from the Bragg reflector. The anti-reflective coating is dimensioned for a laser wavelength λ_{L}, whereby its refractive index is calculated according to \sqrt{n_{GaAs}} whereas n_{GaAs} is used to calculate the laser wavelength λ_{L}, whereby a reflectivity of less than 1% can be achieved without special effort. For the laser wavelength λ_{L}=1064, the anti-reflective coating is made of a layer of silicon oxonitride.

In another advantageous embodiment of the invention, the substrate is made of indium phosphide (InP) and the Bragg reflector consists of individual layers, each with a thickness of

$$\frac{{λ}_{L}}{4 * n} ,$$

whereby the refractive index n_{H} with indium-gallium arsenide (In_{0.53}Ga_{0.47}As) having an indium mole fraction of 53% is used for calculating the first material and the lower refractive indices n_{L} with indium phosphide (InP) is used for calculating the second material (5), moreover, the intermediate layer is made of indium phosphide (InP) on which or within which the single quantum well (6) made of indium-gallium arsenide (InₓGa₁₋ₓAs) is strained with an indium mole fraction x unequal to, especially smaller than, 0.53%, and the indium mole fraction x and its layer thickness define the absorbing effect as a function within a wavelength range, this wavelength range contains the laser wavelength λ_{L} at which a maximum of the absorption curve lies, and the saturation effect and the power resistance are defined by the selection of the distances between the strained single quantum well and the boundary of the reflector. The reflector here is a Bragg reflector and consists of 30 to 100 individual layers.

The cap layer is a passivation layer adjacent to the surroundings and/or an anti-reflective coating. The passivation layer or the anti-reflective coating protects the very thin and chemically unstable strained single quantum well against harmful influences from the surroundings. The passivation layer is dimensioned in such a way that it protects the layers that lie below it, but it influences their optical properties as little as possible. The anti-reflective coating, in addition to the function of a surface protection, has additional optical properties that have a considerable influence on the properties of such a saturable Bragg reflector as compared to a version without an anti-reflective coating. In any case, the influence of the cap layer also has to be taken into account in a calculation of the saturable Bragg reflector, whereby its practical effect can only be determined during operation in a laser resonant cavity.

In a laser resonant cavity, a shortening of the pulse duration of the laser radiation is observed as compared to a version without an anti-reflective coating, when the anti-reflective coating of the saturable Bragg reflector is dimensioned for a laser wavelength λ_{L}.

The anti-reflective coating also brings about a further increase in the power resistance of the resonant cavity mirror. With this anti-reflective coating, the saturable absorber is operated neither resonantly nor anti-resonantly. It also differs from those designated in the literature as “low-finesse” and/or “high-finesse”. Moreover, it is not configured as a broad band but rather it is calculated and manufactured only for the specific laser wavelength.

Furthermore, the pulse duration of the laser radiation in a laser resonant cavity can be shortened in that the strained-layer single quantum well is applied as a low-temperature layer, whereby the lower the selected growth temperature, the lower the pulse duration.

Especially good saturable absorbing properties of the components are achieved if the cap layer is made with the strained-layer single quantum well and if the intermediate layer has an optical thickness of λ_{L}/2 or a whole multiple thereof and if a phase matching is created with the other thicknesses in the layer structure.

The saturable absorbing effect can be set through the selection of the position of the strained-layer single quantum well within the structure of the adjacent layers, whereby these layers each have a greater layer thickness than the single quantum well.

In order to further increase the laser resistance of the saturable reflector or of the saturable absorber, the substrate is attached to a heat sink. In addition to achieving the power dissipation, this heat sink also ensures the required high constancy of the peak power over time.

### BRIEF DESCRIPTION OF THE DRAWINGS

These and other objects of the present invention and various features and details of the operation and construction thereof are hereinafter more fully set forth with reference to the accompanying drawings, wherein:

FIG. 1 is a diagram showing the structure of a saturable Bragg reflector with a strained-layer single quantum well on the basis of a GaAs/AlAs system,

FIG. 2 is a diagram showing the structure of a saturable Bragg reflector with a trained-layer single quantum well and with an anti-reflective coating,

FIG. 3 is a diagram showing the structure of a saturable Bragg reflector with an embedded strained-layer single quantum well,

FIG. 4 is a diagram showing the structure of a saturable Bragg reflector with an embedded strained-layer single quantum well on a metallic reflector,

FIG. 5 is a diagram showing the structure of a saturable absorber with an embedded strained-layer single quantum well on a transparent substrate.

### DETAILED DESCRIPTION OF THE PREFERRED EMBODIMENTS

The invention is described with reference to examples of a saturable Bragg reflector, a saturable reflector and a saturable absorber for the layer system AlAs/GaAs with InₓGa₁₋ₓAs as the strained-layer single quantum well. The dimensioning guidelines and production technologies presented here and supplemented by those generally known to the person skilled in the art, can readily be applied to other layer systems that can be used for the production of a saturable reflector or saturable absorber. In particular, this applies to the materials GaAs, GaP, GaSb, InAs, InP, InSb, AlAs, AlP, AlSb and their alloys (also see FIG. 15 in U.S. Pat. No. 4,597,638).

For the above-mentioned and other materials and other laser wavelengths, it might be necessary to ascertain the above-mentioned corresponding function curves and dependencies in order to be able to undertake a systematic dimensioning for each of the components.

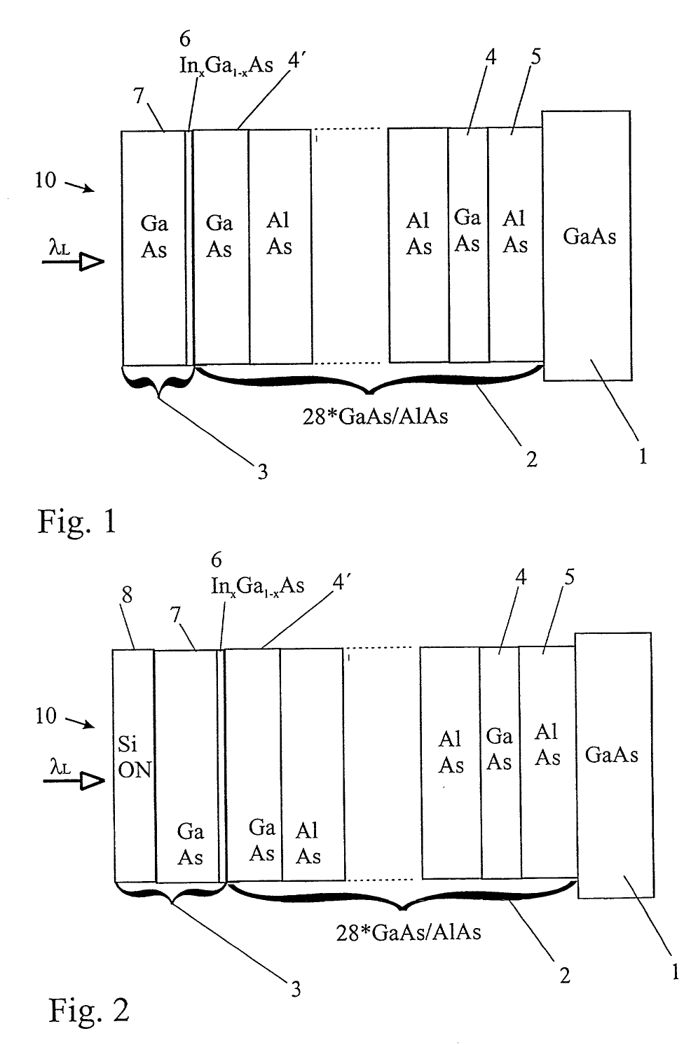

FIG. 1 shows the fundamental layer structure of a saturable Bragg reflector with a strained-layer single quantum well 6, which is applied onto a last layer 4′ of a reflector 2. The reflector 2 in the example is a Bragg reflector. A strained-layer single quantum well 6 and a cap layer 7 form another layer sequence 3.

Twenty-eight layer pairs made of a material 4 with a higher refractive index n_{H} and made of a material 5 with a lower refractive index n_{L} are structured on a substrate 1, and said layer pairs form the Bragg reflector. The thicknesses d of the individual layers result from the refractive indices of the materials 4 and 5 for the particular laser wavelength λ_{L}=1064 nm at

$$\frac{{λ}_{L}}{4 * {n}_{H}}$$

and

$$\frac{{λ}_{L}}{4 * {n}_{L}} .$$

In the example, the higher refractive material 4 is GaAs (n=3.4918) and the lower refractive material 5 is AlAs (N=2.9520).

The calculation of the Bragg reflector can be carried out according to Orazio Svelto: “Principles of Lasers”, Plenum Press, fourth edition, 1998). The layer thicknesses of the individual layers are determined at a laser wavelength λ_{L}=1064 nm for gallium arsenide

$$\frac{{λ}_{L}}{4 * {n}_{GaAs}}$$

at 76 nm in each case and for aluminum arsenide

$$\frac{{λ}_{L}}{4 * {n}_{AlAs}}$$

at 90 nm in each case.

On the last layer 4′ of the reflector 2 made of GaAs, the single quantum well 6 is made of InₓGa₁₋ₓAs, onto which the cap layer 7 made of GaAs is applied. In the example, the single quantum well is strained between the two gallium arsenide layers. For a laser wavelength of 1064 nm, at a thickness of the single quantum well of 7 nm, the result is an indium mole fraction of 33%, as can be seen from FIG. 6 in R. M. Kolbas, N. G. Anderson, W. D. Laidig, Yongkun Sin, Y. C. Lo, K. Y. Hsien, Y. L. Yang: “Strained-Layer InGaAs-GaAs-AlGaAs Photopumped and Current Injection Lasers”, IEEE Journal of Quantum Electronics, Vol. 24, No. 8, 1988, if the energy band gap E [in eV] is converted into the wavelength according to the formula

$$λ = \frac{h * c}{E} ,$$

here the laser wavelength λ_{L}. The saturation behavior and thus the switching behavior generated in a laser resonant cavity and thus the pulse duration can be set especially well and reproducibly through the selection of the distance between the strained indium-gallium arsenide layer and the boundary surface adjacent to a surrounding medium 10 of the laser resonant cavity. The distance is determined by the thickness of the cap layer 7. This has to be dimensioned in such a way that, on the one hand, the desired saturable absorbing effect for the mode synchronization within a laser cavity is achieved and, on the other hand, that a limit of the power resistance of the strained-layer single quantum well 6 is not exceeded.

In actual practice, it has been found that the switching behavior of a saturable Bragg reflector that is only a part of a laser resonant cavity cannot be theoretically predicted with sufficient accuracy. Therefore, a few experiments will be needed to determine the optimal layer thickness of the cap layer 7 so that the intensity of the laser radiation that strikes and reflects back from the saturable Bragg reflector supplies the saturation in the appropriate degree for generating short laser pulses in a laser resonant cavity. It is important for the position of the strained-layer single quantum well 6 to lie so far from the position of a standing wave minimum of the laser radiation that the necessary saturable absorbing effect is achieved in order to generate short laser pulses, for example, in the picosecond range. In the examples, the thickness of the cap layer 7 was selected at FIG. 2 shows a layer structure whose layer sequence 3 is different from that of FIG. 1. In this example, the strained-layer single quantum well 6, the cap layer 7 and an anti-reflective coating 8 form the layer sequence 3. Due to the anti-reflective coating 8 made of SiON, the fraction of the laser radiation reflected at the boundary surface to the surrounding medium 10 is reduced so that, within the saturable Bragg reflector, a higher energy input occurs, which changes the switching behavior. This anti-reflective coating 8 consists of a

$$\frac{{λ}_{L}}{4 * \sqrt{{n}_{GaAs}}}$$

nm thick silicon oxonitride layer. Here, too, it is most advantageous to determine the optimal thickness of the intermediate layer 7 experimentally.

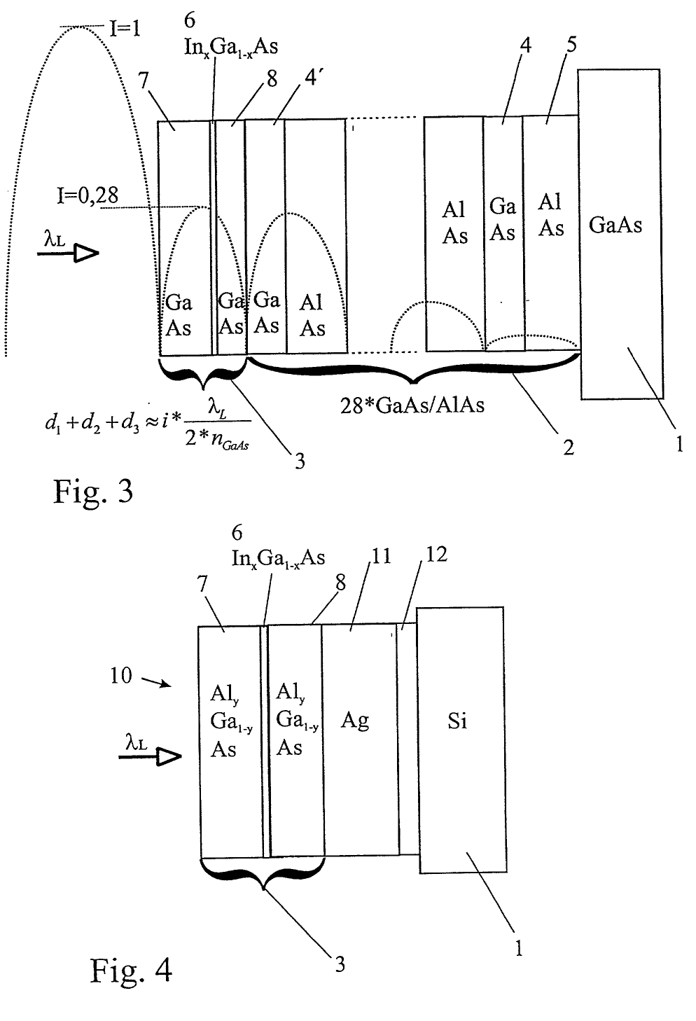

FIG. 3 shows a layer structure whose layer sequence 3 is different from that of FIG. 1. In this example, the strained-layer single quantum well 6, the cap layer 7 and an intermediate layer 9 form the layer sequence 3. The intermediate layer 9 is made of GaAs on which the single quantum well (6) made of InₓGa₁₋ₓAs with an indium mole fraction x=0.15 is applied.

Here, it should be pointed out that the single quantum well 6 is strained between two GaAs layers, whereby none of the layers is a component of the Bragg reflector. The layer thickness of the strained-layer single quantum well is defined as 10 nm, so that a maximum of the absorption lies at 910 nm. In this example, the laser wavelength λ_{L} lies at this wavelength (also see FIG. 2 in J. -Y. Marzin, M. N. Charasse and B. Sermage in “Optical investigation of a new type of valence-band configuration in InₓGa₁₋ₓAs-GaAs strained superlattices”, Phys. Rev., Vol. B31, pp. 8298-8301, 1985). A different thickness and a different material composition of the single quantum well 6 yield an absorption maximum at a different laser wavelength (see FIG. 6 in R. M. Kolbas, N. G. Anderson, W. D. Laidig, Yongkun Sin, Y. C. Lo, K. Y. Hsien, Y. L. Yang: “Strained-Layer InGaAs-GaAs-AlGaAs Photopumped and Current Injection Lasers”, IEEE Journal of Quantum Electronics, Vol. 24, No. 8, 1988).

Here, the desired saturable absorbing effect can be achieved by defining the position of the strained-layer single quantum well 6 within the GaAs layers consisting of the cap layer 7 and of the intermediate layer 9. Another advantage is that the total thickness of the layer sequence 3 can be very well harmonized with the laser wavelength so that phase jumps on the boundary surfaces of the materials are diminished or do not occur at all.

Through the selection of the position of the strained-layer single quantum well 6 between the intermediate layer 9 and the cap layer 7, a simple possibility exists to systematically influence the radiation resistance and the saturable absorbing effect (pulse shape) over a broad range.

The layer sequence 3 should especially be a whole-number multiple i, with i=1, 2, 3, . . . and having an optical thickness of

$$\frac{{λ}_{L}}{2} ,$$

whereby as a rule, i selected as 1, 2 or 3 is sufficient. The strained-layer single quantum well 6, however, always has to lie so far from a standing wave minimum of the laser radiation that the necessary saturable absorbing effect is obtained. The shortest pulse durations were observed when the single quantum well is situated in the standing wave maximum of the laser radiation. However, in this position, the lowest power resistance of the resonant cavity mirror was noted. Here, too, it was found that the pulse shape of the laser radiation depends on the type of laser resonant cavity so that it is advantageous to conduct several experiments to determine where the most favorable position of the strained-layer single quantum well 6 is within the two GaAs layers 7 and 9, whereby both layers should each have a minimum thickness of

$$\frac{{λ}_{L}}{100}$$

in order to be sufficiently far away from a standing wave minimum and in order to generate the lattice strain. The strained-layer single quantum well 6 is preferably situated outside of an intensity maximum of the laser radiation. Practically speaking, the invention uses a position of the strained-layer single quantum well within the layer sequence that lies between the standing wave maximum and the standing wave minimum. Here, too, the cap layer 7 can be coated with the anti-reflective coating 8 in order to increase the energy input into the saturable reflector (not shown).

FIG. 4 shows the structure of a saturable reflector in which the layer sequence 3 is connected with a metal mirror 11 made of silver. As an example, WO 96/36906 (FIG. 9) describes how such a layer structure can be made in principle. The new aspect here is the dimensioning of the layer sequence 3 that contains the strained-layer single quantum well which has to be dimensioned according to the methods named in FIGS. 1, 2 and 3. In this example, the single quantum well made of InₓGa₁₋ₓAs is strained between the cap layer 7 and the intermediate layer 9, both made of Al_{y}Ga_{1-y}As. With the Al mole fraction “y”, the refractive index of the layers can be varied, whereby at a high Al mole fraction “y”, the alloy component AlAs on the surface tends towards oxidation. The lattice spacing only changes slightly with this y-variation, also see, for example, FIG. 15 in U.S. Pat. No. 4,597,638).

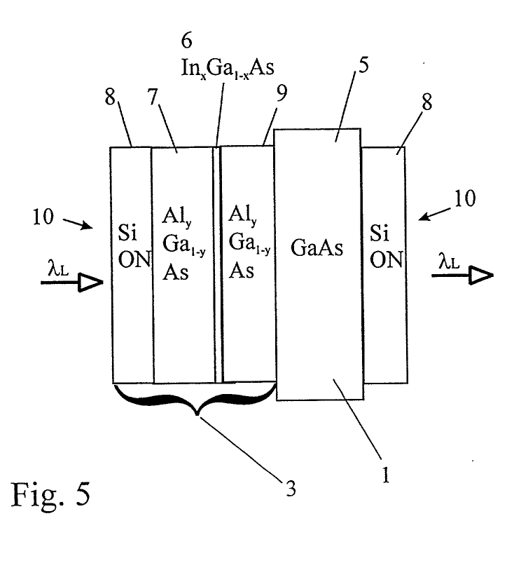

FIG. 5 shows the structure of a saturable absorber (without reflector!) that is arranged on its own within the beam path of a laser resonant cavity, between one of the resonant cavity mirrors and a laser medium.

The layer sequence 3 consisting of the intermediate layer 9, the strained single quantum well 6 and the cap layer 7 is applied onto a substrate 1 that is transparent for the laser wavelength. In this example, the anti-reflective coatings 8 with respect to the surrounding medium 10 belong to the layer structure.

The dimensioning of the layer sequence 3, which contains the strained-layer single quantum well 6, is carried out by means of the methods indicated in FIGS. 1, 2, 3 and 4.

Even though a particular embodiment of the invention has been illustrated and described herein, it is not intended to limit the invention and changes and modifications may be made therein within the scope of the following claims.

What is claimed is:

1. A saturable reflector for a laser wavelength λ_{L} with which a reflector (2) is applied onto a surface of a substrate (1), and a layer sequence (3) with a saturable absorbing effect is applied onto the reflector, characterized in that the layer sequence (3) contains a strained-layer single quantum well (6) and a cap layer (7), whereby the material composition of the single quantum well (6), its layer thickness and its strain in the layer structure within a wavelength range all serve to define an absorbing effect, this wavelength range includes the laser wavelength λ_{L}, and moreover, the degree of the saturable effect is defined by the selection of the distance between the strained single quantum well (6) and the boundary surface of the cap layer adjacent to a surrounding gaseous medium (8, 10).

2. The saturable reflector according to claim 1, characterized in that the lattice strain of the single quantum well (6) occurs with the last layer (4′) of a reflector adjacent to its one side and/or with the cap layer (7) adjacent to its other side.

3. The saturable reflector according to claim 1, characterized in that the layer sequence (3) contains a low-strain intermediate layer (9) adjacent to the reflector (2) and in that the strained-layer single quantum well (6) is surrounded by this intermediate layer (9) and by the cap layer (7).

4. The saturable reflector according to claim 3, characterized in that the material of the intermediate layer (9) is identical to the material of the cap layer (7).

5. The saturable reflector according to claim 3 or claim 4, characterized in that the lattice mismatches of the materials (4, 5) of the reflector and of the material of the intermediate layer (9) are smaller than 0.005 nm, especially smaller than 0.001 nm.

6. The saturable reflector according to one or more of claims 1 through 5, characterized in that the reflector is a Bragg reflector that consists of a first material (4) with a refractive index n_{H} and of a second material (5) with the lower refractive indices n_{L}, and furthermore, the intermediate layer (9) and/or the cap layer (7) consist of one of these materials.

7. The saturable reflector according to one or more of claims 1 through 6, characterized in that the reflector (2) consists of individual layers, each of which has a thickness that is
$$\frac{{λ}_{L}}{4 * {n}_{GaAs}}$$
for the first material (4) with the refractive index n_{H} with undoped gallium arsenide (GaAs) and that is
$$\frac{{λ}_{L}}{4 * {n}_{AlAs}}$$
for the second material (5) with the lower refractive indices n_{L} with undoped aluminum arsenide (AlAs), moreover, the cap layer (7) and the intermediate layer (9) are made of one of these materials (4 or 5), within which the single quantum well (6) made of indium-gallium arsenide (InₓGa₁₋ₓAs) is strained, whereby the indium mole fraction (x) and the gallium mole fraction (1−x) in the indium-gallium arsenide compound and its layer thickness all serve to define the absorbing effect as a function within a wavelength range, this wavelength range comprises the laser wavelength λ_{L}, at which a maximum of the absorption curve lies.

8. The saturable reflector according to one or more of claims 1 through 6, characterized in that the reflector (2) consists of individual layers, each with a thickness that is
$$\frac{{λ}_{L}}{4 * {n}_{InGaAs}}$$
for the first material (4) with the refractive index n_{H} with indium-gallium arsenide (In_{0.53}Ga_{0.47}As) with an indium mole fraction of 53% and that is
$$\frac{{λ}_{L}}{4 * {n}_{InP}}$$
for the second material (5) with the lower refractive indices n_{L} with indium phosphide (InP), moreover, the cap layer (7) and/or the intermediate layer (9) are made of one of these materials (4 or 5), below which and/or on which the single quantum well (6) made of indium-gallium arsenide (InₓGa₁₋ₓAs) is strained with an indium mole fraction x unequal to 0.53%, whereby the indium mole fraction x and its layer thickness define the absorbing effect as a function within a wavelength range.

9. The saturable reflector according to one or more of claims 1 through 5, characterized in that the reflector is a highly reflecting metal mirror (11) on which the layer sequence (3) is applied.

10. The saturable reflector according to claim 1, characterized in that the cap layer (7) is a passivation layer or the cap layer (7) is coated with an anti-reflective coating (8), either layer being adjacent to a gaseous medium (10).

11. The saturable reflector according to claim 1, characterized in that the strained-layer single quantum well (6) is a low-temperature layer.

12. The saturable reflector according to one of claims 3 through 8 or claim 9, characterized in that the cap layer (7) with the strained-layer single quantum well (6) and with the intermediate layer has an optical thickness of λ_{L}/2 or a whole multiple thereof.

13. The saturable reflector according to one or more of claims 1 through 12, characterized in that the saturable absorbing effect is adjustable through the selection of the position of the strained-layer single quantum well (6) within the structure of the adjacent layers, whereby these layers each have a greater layer thickness than the single quantum well.

14. A saturable absorber for a laser wavelength λ_{L}, that consists of a layer sequence (3) of several semiconductor layers with a saturable absorbing effect on a substrate (1) that is transparent for the laser wavelength, characterized in that the layer sequence (3) contains a strained-layer single quantum well (6) and a cap layer (7), whereby the material composition of the single quantum well (6), its layer thickness and its strain in the layer structure all serve to define an absorbing effect within a wavelength range, moreover, a saturable effect is defined by the selection of the position within the standing wave of a laser resonant cavity.

15. The saturable absorber according to claim 14, characterized in that the layer sequence (3) contains a low-strain intermediate layer (9) adjacent to the reflector (2) and in that the strained-layer single quantum well (6) is surrounded by this intermediate layer (9) and by the cap layer (7).

16. The saturable absorber according to claim 15, characterized in that the material of the intermediate layer (9) is identical to the material of the cap layer (7).

17. The saturable absorber according to claim 15 or claim 16, characterized in that the lattice mismatches of the material of the substrate (1) and of the material of the intermediate layer (9) are smaller than 0.005 nm, especially smaller than 0.001 nm.

18. The saturable absorber according to claim 14, characterized in that the cap layer (7) is a passivation layer or the cap layer (7) is coated with an anti-reflective coating (8), either layer being adjacent to a gaseous medium (10).

19. The saturable absorber according to claim 14, characterized in that the strained-layer single quantum well (6) is a low-temperature layer.

20. The saturable absorber according to claim 15, characterized in that the cap layer (7) with the strained-layer single quantum well (6) and with the intermediate layer has an optical thickness of λ_{L}/2 or a whole multiple thereof.

21. The saturable absorber according to one of claims 14 through 20, characterized in that the saturable absorbing effect can be set through the selection of the position of the strained-layer single quantum well (6) within the structure of the layers, whereby these layers each have a greater layer thickness than the single quantum well.
